(19) United States
(12) Patent Application Publication
(10) Pub. No.: US 2014/0164183 A1
(43) Pub. Date: Jun. 12, 2014

(54) Method of Generating Image at Instant Messaging Client, and Image Generating Apparatus and System

(71) Applicant: Alibaba Group Holding Limited, Grand Cayman (KY)

(72) Inventor: Jingxiong Tang, Hangzhou (CN)

(73) Assignee: ALIBABA GROUP HOLDING LIMITED, Grand Cayman (KY)

(21) Appl. No.: 13/636,645

(22) PCT Filed: Jul. 2, 2012
(86) PCT No.: PCT/US12/45294

§ 371 Date: Sep. 21, 2012

(30) Foreign Application Priority Data
Jul. 5, 2011 (CN) 201110188120.5

(51) Int. Cl. G06Q 30/06

(52) U.S. Cl. CPC G06Q 30/0623
USPC 705/26.61

(57) ABSTRACT

A client device receives item link information associated with a transaction of an item. The client device may retrieve predetermined verification parameters based on the item link information. Based on the parameters, the client device may obtain the item feature information that corresponds to the predetermined verification parameters. The client device may then generate the item information image, and display the item information image.

### CROSS REFERENCE TO RELATED PATENT APPLICATIONS

This application is a national stage application of an international patent application PCT/US12/45294, filed Jul. 2, 2012, which claims priority to Chinese Patent Application No. 201110188120.5, filed on Jul. 5, 2011, entitled “Method of generating image at instant messaging client, and image generating apparatus and system,” which applications are hereby incorporated by reference in their entirety.

### TECHNICAL FIELD

This disclosure relates to the field of computer network technology. More specifically, the disclosure relates to generating images in an instant messaging client system.

### BACKGROUND

Due to the continuous development of electronic commerce (i.e., e-commerce) websites, more and more people are starting to purchase items through the internet. In such websites, images and other features of the items are displayed through the networks. Moreover, buyers and sellers often use instant communication devices to send transactional information to each other to reach a deal. When both parties communicate with each other, they send out item links to advertise or confirm item information. Via the links, the parties can obtain the related image information of the item, and thus get a more intuitive feeling of the item.

In current technologies, a server transmits the image via instant messaging for a client to see item images. After a client device receives images, it displays the image locally. If the size of the image is big, a large amount of bandwidth may be consumed. This may present problems, for example, when there is a limit to the network bandwidth.

### SUMMARY

The present disclosure concerns a method for generating images in an instant messaging client. The instant messaging client device may retrieve link information. If the link information is associated with item information, the device may retrieve predetermined verification parameters of the item link information. Also, the device may retrieve from the server item feature information that corresponds to the predetermined verification parameters. The device may then generate an item information image, and display the image.

In some aspects, the item information image may be generated based on the item feature information and image layout strategy data. The item information image may be generated based on at least one of the image layout strategies and the item's images, image styles, prices or quantity information. The device may retrieve the item feature information that corresponds to the predetermined verification parameters from the item information server.

In some aspects, the device may include a first retrieval unit, an assessment unit, a second retrieval unit, a calculation saving unit and a display unit.

### BRIEF DESCRIPTION OF THE DRAWINGS

The Detailed Description is described with reference to the accompanying figures. The use of the same reference numbers in different figures indicates similar or identical items.

FIG. 1 is a flow diagram of an illustrative process to generating images in an instant messaging client.

FIG. 2 is a flow diagram of another illustrative process to generating images in an instant messaging client.

FIG. 3 is a block diagram of an illustrative device that generates images.

FIG. 4 is a block diagram of an illustrative environment that supports generating images.

### DETAILED DESCRIPTION

The exemplary embodiments of the present disclosure as discussed below include methods for searching, and computing devices for, for example, generating images. The exemplary embodiments described are merely a portion of the present disclosure's exemplary embodiments, and do not include all of the exemplary embodiments. For the ordinary technical persons in the art, if they have obtained other exemplary embodiments under the premise that no creative efforts are exerted, these exemplary embodiments fall under the protective scope of the present disclosure.

In this disclosure, an item information image can be generated based on item information data and image style downloaded by a client device from a server. The client device may generate and store images, and thus decrease calculation amount and storage needed in the server to save costs. Based on the item information data and image style downloaded from the server, the client device can generate item information images that satisfy requirements. The client device may also generate formats of the item information image and content of configuration files that are downloaded from the server. This can satisfy the scalability of generated images.

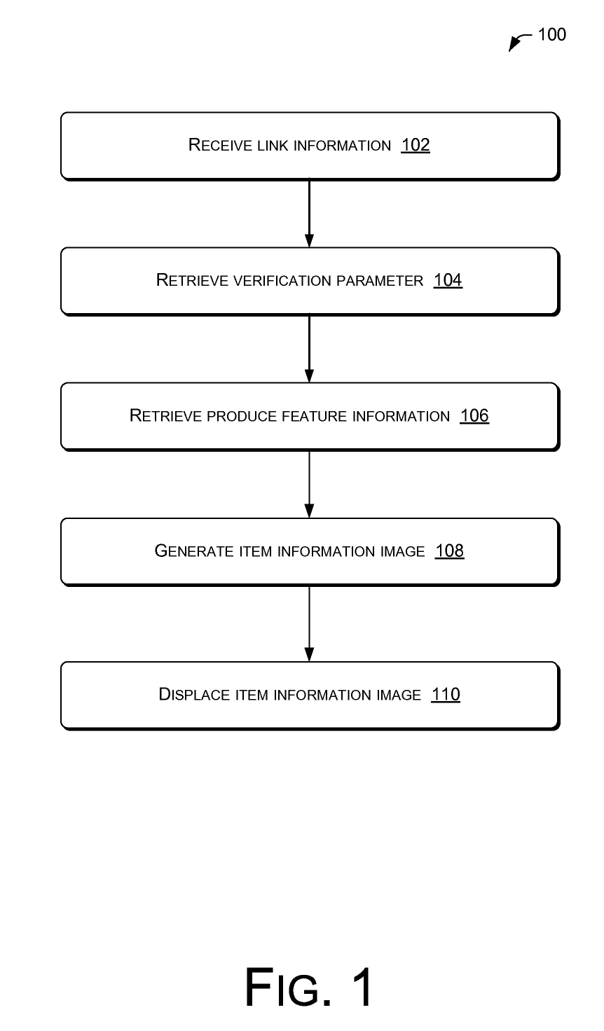

FIG. 1 is a flow diagram of an illustrative process 100 to generating images in an instant messaging client. At 102, the client device may retrieve link information. This may be implemented using an instant messaging. For example, the link information may be included in messages that are transmitted from a user to another user. At 104, the client device may retrieve predetermined verification parameters after determining that the link information includes item link information. At 106, the client device may retrieve item feature information. At 108, the client device may then generate item information image. At 110, the client device may display item information image.

In some embodiments, the link information from the server can be obtained by using software installed in the client device. The software may include an instant messaging application, e.g., Tao-Bao-Wang-Wang. The client device may assess whether the link information includes item link information. This assessment may be implemented using regular expressions. In some embodiments, rules of the regular expressions are determined by requesting parties. For example, “fixed domain name+special parameter name” may be used for the assessment. If the link information includes item link information, the client device may retrieve predetermined verification parameters included in the item link information. Link formats associated with the item link information may be predefined. The predetermined verification parameters may include different characteristics (e.g. domain name and parameters).

In some embodiments, the client device may assess the characteristics to determine whether the link is an item link. If the link is an item link, the client device may further determine what items are indicated in the link, and retrieve the predetermined verification parameters to obtain from an item information server the item feature information that corresponds to the predetermined verification parameters. The client device can also download the retrieved item feature information. Based on the item feature information, the client device may generate the item information image. In some embodiments, the image can be generated in the client device locally. For example, an instant messaging client may retrieve the corresponding information from the item information server (e.g. item images, item names, logos, quantities, prices, and layouts).

In some embodiments, based on the item feature information, the client device may perform calculations to generate an image. For example, the instant messaging client of the client device may retrieve from the server item names (e.g., in text formats), item quantities (e.g., in text formats), item prices (e.g., in text formats), item images (e.g., in image formats), and other icons (e.g., in image formats). The other icons may indicate reputations of users, e.g., whether users are loyal users or users in good faith. The instant messaging client may also retrieve a pre-configured image layout strategy data (e.g., layout file), which may indicate where the item name and item image are displayed, and other related information.

In some embodiments, based on the layout file and item name, price and other such information, the client device may generate an item information image that includes the image and/or text information as well as image/icon information, and display the item information image. The client device may also save the generated item information image in a predetermined space of an interface of an instant messaging application. The client device may, based on the user's requirements, display the generated item information image to the user to enable the user to have a more intuitive and sensible knowledge of the item.

In some embodiments, the predetermined verification parameters can be set as one or more feature codes that correspond to an item. For example, for a certain brand of shoes, such as COOL, its corresponding feature code may be assigned as XZCOOL. Based on actual requirements, the feature codes can be defined as one-dimensional or two-dimensional code. In some embodiments, they can also be multi-dimensional or other types of codes that can be used as differentiators or identifiers.

In some embodiments, the item feature code can include item information data and image layout strategy. The item information data can include the item's images or image styles, prices and quantities and other such parameters. The item information data can also include other parameters that identify the item features.

In some embodiments, a client A may retrieve the link information from client B. The client A may assess whether the link information obtained from client B includes item link information. If the link information includes item link information, client A may retrieve predetermined verification parameters of the item link information from client B. Based on the predetermined verification parameters, the client A may retrieve the item feature information that corresponds to the predetermined verification parameters from an item information server that may store information related to the item. This stored item feature information can be predetermined by platform operators or refreshed in the server in predetermined time period. The item feature information may be uploaded by sellers from client devices to the server. The client A can download the retrieved item feature information locally. Based on the item feature information, a client device associated with the client A may generate the item information image locally. The client device may store the generated item information image in a local predetermined space. After generating the item information image, based on the user's requirements, the client device may display the generated item information image. In some embodiments, the server may perform searches for the item that corresponds to the predetermined verification parameters, and then retrieve the item's feature information.

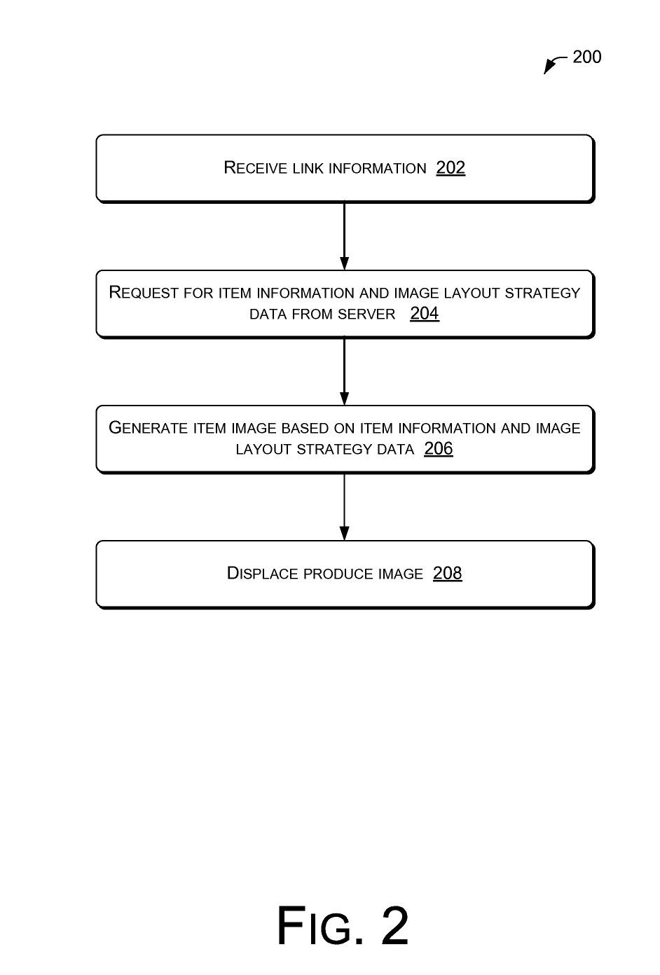

FIG. 2 is a flow diagram of another illustrative process 200 for generating images. At 202, a client device may receive link information. In some embodiments, the client device may transmit link information to another client device or receive the link information from another client device. The client device may obtain the predetermined verification parameters from the other client device or a server. At 204, the client device may request for the item feature information and image layout strategy data from the server. For example, the client device may transmit a query or a request to the server for item feature information that corresponds to the predetermined verification parameters. Based on the query, the server may perform searches to obtain the item feature information.

At 206, the client device may generate item information image based on the item information data and the image layout strategy data. At 208, the client device may display the generated image.

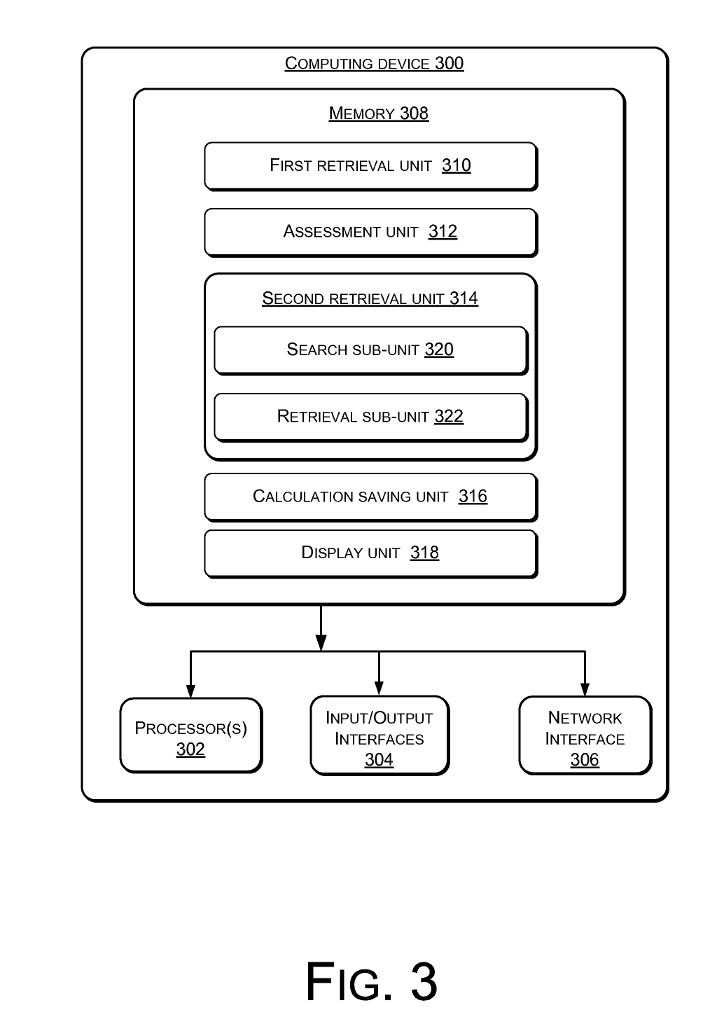

FIG. 3 is a block diagram of an illustrative device 300 that generates images. The device 300 may be configured as any suitable computing device(s). In one exemplary configuration, the device 300 includes one or more processors 302, input/output interfaces 304, network interface 306, and memory 308.

The memory 308 may include computer-readable media in the form of volatile memory, such as random-access memory (RAM) and/or non-volatile memory, such as read only memory (ROM) or flash RAM. The memory 308 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

Turning to the memory 308 in more detail, the memory 308 may store a first retrieval unit 310, assessment unit 312, a second retrieval unit 314, a calculation saving unit 316, and a display unit 318. The second retrieval unit 314 may further include a search sub-unit 320 and a retrieval sub-unit 322.

The first retrieval unit 310 may retrieve the link information from the instant messaging client. The assessment unit 312 may assess if the link information includes item information. If yes, the predetermined verification parameters of the item link information may be retrieved. The second retrieval unit 314 may retrieve the item feature information that corresponds to the predetermined verification parameters. The calculation saving unit 316 may generate the item information image and save it. The display unit 318 may display the item information image.

In some embodiments, the search sub-unit 320 may perform searches for the items that correspond to the predetermined verification parameters, and the retrieval sub-unit 322 may retrieve the item feature information.

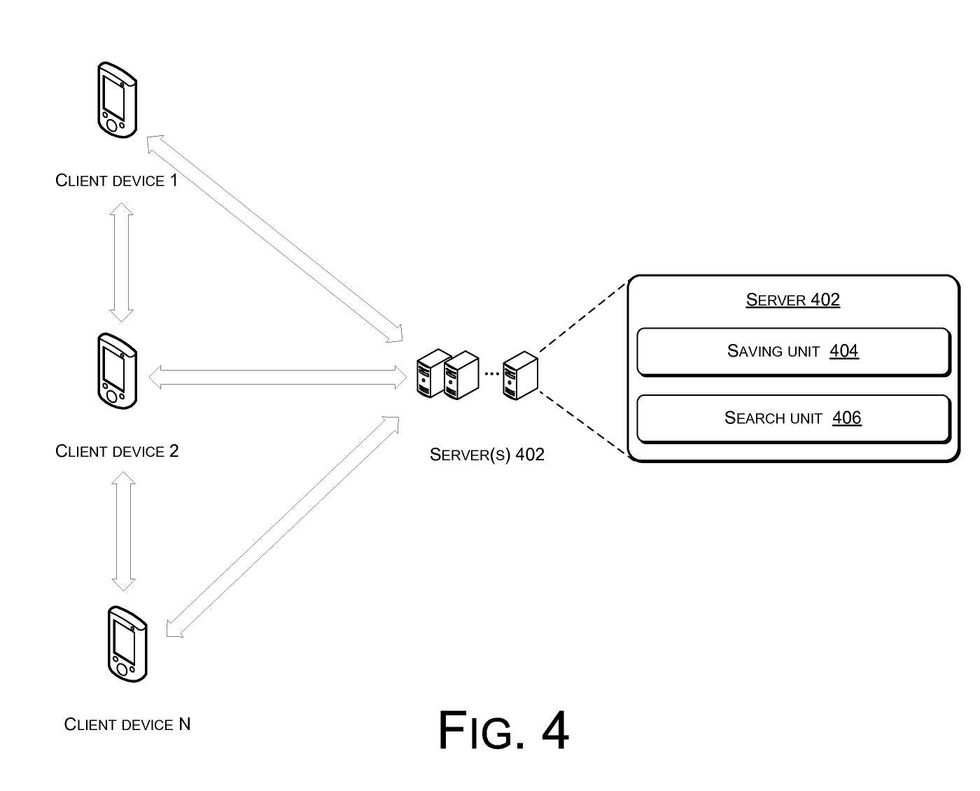

FIG. 4 is a block diagram of an illustrative environment that supports generating images. The server 402 may include a saving unit 404 and a search unit 406. The saving unit 404 may save the item feature information. The search unit 406 may perform searches for the item feature information that correspond to the predetermined verification parameters.

The specific examples herein are utilized to illustrate the principles and embodiments of the application. The description of the embodiments above is designed to assist in understanding the method and ideas of the present disclosure.

However, persons skilled in the art could, based on the ideas in the application, make alterations to the specific embodiments and application scope, and thus the content of the present specification should not be construed as placing limitations on the present application.

What is claimed is:

1. One or more computer-readable media storing computer-executable instructions that, when executed by one or more processors, instruct the one or more processors to perform acts comprising:
receiving a message associated with a transaction of an item;
retrieving one or more parameters associated with the item based on the message;
obtaining one or more item features associated with the item based on the one or more parameters; and
generating an item information image based on the one or more item features.

2. The one or more computer-readable media of claim 1, wherein the acts further comprise displaying the item information image.

3. The one or more computer-readable media of claim 1, wherein the acts further comprise determining that the message is associated with the transaction of the item based on a predetermined rule.

4. The one or more computer-readable media of claim 1, wherein the one or more item features include at least one of an item image, an item name, a logo associated with the item, or an item price.

5. The one or more computer-readable media of claim 1, wherein the generating the item information image comprises generating the item information image based on the one or more item features and image layout strategy data.

6. The one or more computer-readable media of claim 1, wherein the one or more item features indicates a reputation of a user associated the transaction.

7. The one or more computer-readable media of claim 1, wherein the obtaining the one or more item features comprises obtaining the one or more item features from a client device associated with a user of the transaction.

8. The one or more computer-readable media of claim 1, wherein the obtaining the one or more item features comprises obtaining the one or more item features from a server associated with the transaction.

9. The one or more computer-readable media of claim 1, wherein the item information image is generated at a client device.

10. The one or more computer-readable media of claim 1, wherein the parameters include a domain name.

11. A method comprising:
under control of one or more client devices comprising one or more processors,
receiving link information;
retrieving one or more parameters from the link information, the one or more parameters being specified based on a predetermined rule;
obtaining item feature information associated with a transaction of an item based on the one or more parameters; and
generating an item information image based on the item feature information.

12. The method of claim 11, further comprising:
determining whether the link information includes transaction information associated with an item;
in an event that the link information includes transaction information associated with an item, retrieving the one or more parameters from the link information; and
displaying the item information image by a client device.

13. The method of claim 11, wherein the item feature information include at least one of a item image, a item name, a logo associated with the item, or a item price.

14. The method of claim 11, wherein the generating the item information image comprises generating the item information image based on the item feature information and image layout strategy data.

15. The method of claim 11, wherein the item feature information indicates a reputation of a user associated the transaction.

16. The method of claim 11, wherein the receiving the link information is implemented using an instant messaging.

17. A computing device comprising:
one or more processors; and
memory to maintain a plurality of components executable by the one or more processors, the plurality of components comprising:
a first retrieval unit that receives link information from a client device using instant messaging,
an assessment unit that determines that the link information is associated with a transaction of an item,
a second retrieval unit that obtains item feature information associated with the item, and
a calculation saving unit that generates an item information image based on the item feature information.

18. The device of claim 17, wherein the item feature information include at least one of a item image, a item name, a logo associated with the item, or a item price.

19. The device of claim 17, wherein the generating the item information image comprises generating the item information image based on the item feature information and image layout strategy data.

20. The device of claim 17, wherein the obtaining the item feature information comprises obtaining the item feature information from a server associated with the transaction.
